(19) United States
(12) Patent Application Publication
(10) Pub. No.: US 2019/0047253 A1
(43) Pub. Date: Feb. 14, 2019

(54) ADHESION PROMOTER LAYER FOR JOINING A HIGH-TEMPERATURE PROTECTION LAYER TO A SUBSTRATE, AND METHOD FOR PRODUCING SAME

(71) Applicant: FORSCHUNGSZENTRUM JUELICH GMBH, Juelich (DE)

(72) Inventors: Robert VASSEN, Herzogenrath (DE); Jan BERGHOLZ, Juelich (DE); Daniel Emil MACK, Koeln (DE); Willem J. QUADAKKERS, Wijnandsrade (NL)

(21) Appl. No.: 16/075,160

(22) PCT Filed: Feb. 3, 2017
(86) PCT No.: PCT/DE2017/000017

§ 371 Date: Aug. 3, 2018

(30) Foreign Application Priority Data
Mar. 7, 2016 (DE) 10 2016 002 630.8

(51) Int. Cl. B32B 15/01; C22C 19/05; C23C 28/00

(52) U.S. Cl. CPC B32B 15/01; C22C 19/056; C23C 28/3455; C22C 19/058; C23C 28/3215; C22C 19/057

(57) ABSTRACT

An adhesion promoter layer for joining a high-temperature protection layer to a substrate includes a first layer of a first adhesion promoter material, provided for application to the substrate, and a second layer, arranged on the first layer and including a second adhesion promoter material having additionally introduced oxide dispersions, which is provided for joining a high-temperature protection layer.

### CROSS REFERENCE TO RELATED APPLICATIONS

This application is a U.S. National Stage Application under 35 U.S.C. § 371 of International Application No. PCT/DE2017/000017 filed on Feb. 3, 2017, and claims benefit to German Patent Application No. DE 10 2016 002 630.8 filed on Mar. 7, 2016. The International Application was published in German on September 14, 2017, as WO 2017/152891 A1 under PCT Article 21(2).

### FIELD

The invention relates to a novel adhesion promoter layer for joining a high-temperature protection layer, such as a thermal insulation layer or an environmentally stable (thermal) protection layer, to a substrate, and to a method for producing same.

### BACKGROUND

Thermal insulation layers (thermal barrier coatings, TBCs) are understood to be protective layers on components subjected to heat which are intended to reduce the material temperature of the components in high-temperature applications. Thermal insulation layers have layer thicknesses in the range of a few tenths of a millimeter to a number of millimeters, depending on the requirements.

Thermal insulation layers thus help to preserve the strength of the material of the component even at very high temperatures. Thus, for example, turbine blade materials can be used at exhaust gas temperatures of over 1400° C., since a thermal insulation layer can reduce the temperature of the material to less than 1100° C., at which the material still has sufficiently high strength.

Thermal insulation layers are generally a very effective protection against the extreme hot-gas temperatures which are reached; further high-temperature protection layers protect components subjected to heat in aggressive environments, and also moreover against oxidation, corrosion or even erosion.

The application of high-temperature protection layers of this type imposes strict requirements during production, since the coatings as a rule have a ceramic structure which is both porous and brittle.

The joining of high-temperature protection layers to the corresponding components is often improved by the use of what are known as adhesion promoter layers. This results in multilayer systems which combine good mechanical characteristics with chemical and thermal stability.

Adhesion promoter layers generally exhibit a particular surface structure which makes possible excellent joining of the actual functional layer (thermal insulation, corrosion protection, erosion protection etc.) to the component to be protected. Since the functional layer is generally porous, the adhesion promoter layer also takes on a protective function for the substrate (component) against aggressive atmospheres in high-temperature operation. Typically, in this case, resistant, protective oxide layers, for example Al₂O₃, Cr₂O₃ or SiO₂, are formed at the boundary surface, which as a rule slow down a further oxidation attack and are referred to as thermally grown oxides (TGO).

However, after a critical oxide layer thickness has been reached, which is normally formed after a critical number of temperature-change stresses, crack formation often occurs as a result of thermal stress, erosion and/or corrosion, in particular at or directly above the boundary surface between the protective oxide layer of the adhesion promoter layer and the high-temperature protection layer. Alongside other effects, as a rule this subsequently results in failure of the high-temperature protection layers. This effect of the loss of the coating is also known as spallation. The thermally grown oxides thus reach typical layer thicknesses of between 1 to 10 μm, but rarely more, before peeling occurs.

Thus, for long-term provision of a protective function, a sufficiently large reservoir of elements capable of forming an oxide layer has to be present in the adhesion promoter layer; this means that in particular a minimum layer thickness for an adhesion promoter layer of this type is required. Known adhesion promoter layers typically have a layer thickness of between 50 and 200 μm.

In the past, approaches for improving the service life of thermal insulation layers have already been proposed.

For example, a thermal insulation layer system for use in gas turbine engines is already known from the joint E.U. and U.S.A. HIPERCOAT project, in which a 50 μm thick insulating layer of yttrium-stabilized zirconium dioxide, which may be applied by means of methods such as plasma spraying and electron beam physical vapor deposition (EBPVD), was used between the material of the thermal insulation layer and the thermally grown oxide (TGO) of the adhesion promoter layer.

A further approach provides the use of a two-layer adhesion promoter layer. For this purpose, Quadakkers et al. [1] propose for example producing a first layer on a substrate by high-velocity flame spraying (high-velocity oxy-fuel, HVOF) and applying a second, thinner layer (flashcoat) of the same material thereto by air or atmospheric plasma spraying (APS). The upper flashcoat layer has a higher roughness than the first adhesion promoter layer and, by comparison with the first layer, leads to a service life which is 2 to 3 times longer. The ratio of the layer thicknesses of the upper to the lower adhesion promoter layer is generally between 1:5 and 1:3 in this context.

EP 1076727 B1 also discloses a two-layer adhesion promoter layer in which a first layer of a first material of a maximum size of 55 μm is applied to a superalloy substrate by high-velocity flame spraying (high-velocity oxy-fuel, HVOF), and a second layer of a second material of a size of between 35 and 110 μm is applied thereto by air or atmospheric plasma spraying (APS). After each application, a thermal treatment is carried out to compact the layers. The first and the second material may comprise the same material, in particular MCrAl or MCrAlY, where M=iron, nickel and/or cobalt as well as mixtures thereof

A two-layer adhesion promoter layer is also further known from U.S. Pat. No. 8,497,028 B1. This comprises a first oxidation-resistant layer arranged on a substrate and a second spallation-resistant layer arranged thereon. The oxidation-resistant layer may comprise an MCrAlY, for example an MCrAlY comprising 20-24% by weight cobalt, 14-18% by weight chromium, 11-13.5% by weight aluminum, 0.1-0.4% by weight hafnium, 0.4-0.8 yttrium, 0.4-0.7% by weight silicon and the remainder nickel. The spallation-resistant layer is suitable in particular for forming a thermally grown oxide layer, and has for example a composition of 10-13% by weight cobalt, 5.5-7.0% by weight chromium, 3.0-6.0% by weight tantalum, 3.0-5.0% by weight tungsten, 1.1-1.7% by weight molybdenum, 9.0-11% by weight aluminum, 0.2-0.6% by weight hafnium, 0.3-0.7% by weight yttrium, 0.1-0.3% by weight silicon, 0.1-0.2% by weight zirconium and the remainder nickel. Alternatively, the spallation-resistant layer may also for example have a composition of 11-14% by weight cobalt, 11-14% by weight chromium, 7.5-9.5% by weight aluminum, 0.1-0.5% by weight hafnium, 0.2-0.6% by weight yttrium, 0.1-0.3% by weight silicon, 0.1-0.2% by weight zirconium and the remainder nickel.

The use of adhesion promoter layers comprising oxide dispersion-strengthened (ODS) superalloys has likewise been discussed previously. Materials of this type are used for example for the blades, which are subjected to extremely high temperatures, of gas turbines. In particular, nickel alloys are frequently used ODS materials. For particular applications, however, iron-aluminum alloys or precious metal alloys are used as ODS materials.

ODS alloys refers to alloys which are particle-reinforced by oxides and produced using powdered metal, these frequently being used for increasing the creep resistance of components subject to high temperatures. ODS alloys substantially consist of a metal base material, generally of a metal high-temperature alloy, for example an iron-aluminum alloy, an iron-chromium alloy, an iron-chromium-aluminum alloy, a nickel-chromium alloy or a nickel aluminate. Highly stable oxides, such as yttrium oxide (Y₂O₃) or aluminum oxide (Al₂O₃), are incorporated into these so as to be atomically finely distributed. As a rule, the oxide particles are of a size of between 5 and 50 nm. ODS alloys are generally produced by mechanical alloying of the powder in question in a ball mill.

Seiler et al. [2] analyzed typical thermal insulation layer systems, each comprising an adhesion promoter layer, a thermal insulation layer (TBC) as an actual functional layer, and a thermally grown oxide (TGO) layer between the adhesion promoter layer and the functional layer. It was found that the service life of the coating system is dependent not only on the sintering property of the functional layer, the growth rate of the thermally grown oxide layer, the roughness at the boundary surface and the thermal expansion coefficient of the layers involved, but also on the creep property of the adhesion promoter layer. It was concluded that an adhesion promoter layer having slow creep properties (high creep resistance), such as are brought about using ODS alloys, can reduce the service life but can also reduce the stresses within the thermal insulation layer.

### SUMMARY

In an embodiment, the present invention provides an adhesion promoter layer for joining a high-temperature protection layer to a substrate. The adhesion promoter layer includes a first layer of a first adhesion promoter material, provided for application to the substrate, and a second layer, arranged on the first layer and including a second adhesion promoter material having additionally introduced oxide dispersions, which is provided for joining a high-temperature protection layer.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1(a) shows a light microscope image of a cross-section of an ODS powder on a 10 μm scale;

FIG. 1(b) shows a light microscope image of a cross-section of an ODS powder on a 50 μm scale with embedded oxide dispersions;

FIG. 2(a) is a graph showing that, at 1445 cycles, a sample according to an embodiment of the invention comprising a second ODS adhesion promoter layer has a longer service life than thermal insulation systems not comprising an ODS adhesion promoter layer;

FIG. 2(b) is an image showing a microstructure of a thermal insulation layer system in accordance with an embodiment of the invention;

FIG. 3(a) shows the basic structure of an adhesion promoter layer according to an embodiment of the invention; and

FIG. 3(b) shows the basic structures of prior art adhesion promotor layers.

### DETAILED DESCRIPTION

Embodiments of the invention provide novel, cost-effective protective layer systems that provide for particularly good joining to a component and additionally a longer service life than has been known thus far.

In the context of the invention, it has been found that the drawbacks of the previous prior art for an adhesion promoter layer for high-temperature protection layers or functional layers can be overcome by a novel, two-layer adhesion promoter layer. The basic idea is that the novel adhesion promoter layer is constructed from a first, thicker adhesion promoter layer, provided as a reservoir for forming an oxide layer and for arrangement on a substrate, and a second, advantageously thinner adhesion promoter layer, which is arranged on the first layer and has a different composition from the first layer.

It has been found that the quality of the thermally grown oxidation layer (TGO) of an adhesion promoter layer and the behavior of the boundary layer between the functional layer and the TGO layer are primarily determined by the uppermost layer of the adhesion promoter layer, which is in contact with the functional layer. This is the approach taken by embodiments of the invention.

According to embodiments of the invention, the lower, first layer of the adhesion promoter layer, which is provided for joining to a substrate, has a typical adhesion promoter material, for example the previously known MCrAlY material comprising cobalt, nickel and/or iron, as the metal M. Suitable materials for the first layer are for example NiCoCrAlY materials, such as Co27Cr9AI0.5Y, Ni30Cr11AI0.5Y, Co32Ni21Cr8AI0.5Y, Ni23Co18Cr12.5AI0.5Y or else Ni20Co18Cr12.5AI0.6Y.

By contrast, according to embodiments of the invention, the upper, second layer of the adhesion promoter layer, which is provided for joining a high-temperature protection layer, has a particularly oxidation-resistant and additionally creep-resistant material, in other words a material having slow creep rates. In particular, oxide dispersion-strengthened (ODS) alloys made of for example MCrAl or MCrAlY material comprising cobalt, nickel and/or iron as the metal M are suitable for this purpose. In particular yttrium, aluminum, zirconium or hafnium oxide or else rare earth oxides are conceivable as stable, finely distributed oxide dispersions. The oxide dispersions may be introduced into the matrix alloy in advance by mechanical alloying, for example by way of a high-energy attritor.

As a rule, these ODS materials used for the second adhesion promoter layer have a positive influence on the growth rate of the thermally grown oxide (TGO) layer, in other words the growth rate is for example greatly reduced, and this as a rule leads to a longer service life of the adhesion promoter layer before cracks form.

For this purpose, the second layer should comprise oxide dispersions in a proportion by weight of at least 0.01% by weight to at most 50% by weight, preferably in a proportion of 0.1 to 5% by weight.

If an adhesion promoter layer of this type is used in a system of component/adhesion promoter layer/high-temperature protection layer, this also leads to a longer service life of the applied high-temperature protection layer before peeling and thus to an increased service life of the component to be protected.

In addition, adhesion promoter layers according to embodiments of the invention also favorably influences the stress state both in the adhesion promoter layer itself and in the high-temperature protection layer. As a result of the use of the two-layer adhesion promoter layer according to embodiments of the invention, a system of component/adhesion promoter layer/high-temperature protection layer can thus be greatly improved.

Moreover, two-layer adhesion promoter layers according to embodiments of the invention can be used in protective layers for ceramic fiber composite materials. In this context, in particular C/C, C/SiC, SiC/C—SiC or SiC/SiC may be used as ceramic, non-oxidic substrates (fiber composite materials), these composite ceramics usually being abbreviated in the form “fiber type/matrix type”. Thus, “C/C” stands for carbon-fiber-reinforced carbon and “C/SiC” stands for carbon-fiber-reinforced silicon carbide. In ceramic fiber composite materials, Si is frequently used as an adhesion promoter material. In this context, the adhesion promoter layers according to embodiments of the invention comprise a first, thermally sprayed adhesion promoter layer, comprising for example Si or Si alloys, such as MoSi₂, in other words typically SiO₂ producers, which is arranged on the substrate.

The properties of the adhesion promoter material used for the first layer for ceramic fiber composite materials may also be improved by oxide dispersions, and be arranged on the first layer as a second, thin, thermally sprayed layer of an ODS material (Si alloy). For this purpose too, yttrium, aluminum, zirconium or hafnium oxide or else rare earth oxides may be used as stable, finely distributed oxide dispersions.

As the actual protective layer for a ceramic fiber composite material, in particular thermally sprayed protective layer top layers of corrosion-resistant materials, for example rare earth silicates, such as Yb₂Si₂O₇, are conceivable.

The ODS materials used for the second, upper adhesion promoter layer are generally more expensive than the adhesion promoter materials used for the lower, first layer.

In an advantageous embodiment of the invention, it is therefore proposed to provide a combination of a first, thicker layer as a reservoir layer and a second, thinner layer, which is thus advantageously highly cost-efficient, in an adhesion promoter layer.

Preferably, the upper, second layer comprising the ODS material is only half as thick as the lower, first layer. In a particular embodiment of the invention, the upper, second layer comprising the ODS material only has 30% of the layer thickness of the lower, first layer, preferably even only 20% or less of the layer thickness of the lower, first layer.

In total, two-layer adhesion promoter layers according to various embodiments of the invention can have a layer thickness of between 50 and 300 μm, preferably between 100 and 200 μm. In this context, the second layer comprising the ODS material should at least have a layer thickness of 10 μm.

As application methods for applying the first adhesion promoter layer to for example a component, in particular thermal spraying methods are suitable, such as high-velocity, oxygen or air flame-spraying (HVOF, high-velocity oxygen fuel, or HVAF, high-velocity air fuel), vacuum plasma spraying, cold gas spraying, or atmospheric plasma spraying.

As application methods for applying the second, upper adhesion promoter layer to the first adhesion promoter layer, all conventional methods are also suitable, such as high-velocity flame spraying (HVOF, high-velocity oxygen fuel, or HVAF, high-velocity air fuel), vacuum plasma spraying, cold gas spraying, or atmospheric plasma spraying.

In general, for the application of the second, upper adhesion promoter layer, the same methods may be used as for the first layer. Because of the higher creep resistance, however, methods using a higher kinetic energy, such as cold gas, HVOF, or HVAF spraying may be advantageous.

To summarize, embodiments of the invention provide improved adhesion promoter layers, in which a first adhesion promoter layer is produced from a first material, this adhesion promoter material is strengthened and improved in particular by introducing oxide dispersions, and this improved material is additionally applied as a thin second layer to the previously deposited first adhesion promoter layer.

In this way, the first and the second adhesion promoter layer may in principle comprise the same base material, although stable oxides such as yttrium or zirconium oxide are incorporated, atomically extremely finely dispersed as oxide dispersions, into the material of the second layer, and this material is thus in the form of an ODS layer. This is advantageous in particular because it slows down the interdiffusion. However, different pairings are also possible, such as a first layer comprising NiAl along with a second layer comprising an ODS-NiCoCrAlY material or a first layer comprising pure Si along with a second layer comprising an ODS-MoSi₂ material.

High-temperature protection layers which can advantageously be joined to metal or ceramic components by way of adhesion promoter layers according to embodiments of the invention include in particular thermal insulation layers (TBCs) and environmentally stable (thermal) protection layers (ETBCs, environmental and thermal barrier coatings).

According to a first configuration, a thermal insulation layer system comprising a superalloy as a substrate (component) is provided, and arranged thereon is a two-layer adhesion promoter layer, and an actual functional layer optionally arranged on the adhesion promoter layer. Nickel-based alloys are used as substrates. The adhesion promoter layer comprises a first, thermally sprayed Ni23Co18Cr12AI0.5Y layer, arranged on the substrate, as an adhesion promoter layer, which is applied by the method of vacuum plasma spraying, and a second, thinner, likewise thermally sprayed ODS-MCrAlY layer arranged thereon, comprising 1% by weight AI₂O₃ dispersions. The oxide dispersions are introduced into said MCrAlY material, used for the first layer, in advance by mechanical alloying. The ODS-MCrAlY layer is likewise applied by the VPS method. As a functional layer, which may also be multi-layer, for example a thermal insulation layer (TIL), a corrosion protection layer or an environmentally stable (thermal) protection layer (ETBC) is conceivable.

According to a second configuration, a ceramic composite material is provided that includes an, in particular, non-oxidic substrate, and arranged thereon is a two-layer adhesion promoter layer, and an actual functional layer optionally arranged on the adhesion promoter layer. In particular C/C, C/SiC, SiC/C—SiC, SiC/SiC or AI₂O₃/AI₂O₃ may be used as ceramic, non-oxidic substrates, these composite ceramics conventionally being abbreviated in the form “fiber type/matrix type”. The adhesion promoter layer arranged thereon comprises a first, thermally sprayed adhesion promoter layer, arranged on the substrate, comprising pure Si, and a second, thin, thermally sprayed layer made of an ODS material, in this case Si comprising 1% by weight Y₂O₃, arranged thereon.

As a protective layer for the ceramic fiber composite material, in particular thermally sprayed protective layer top layers of corrosion-resistant materials (rare earth silicates, such as Yb₂Si₂O₇) are conceivable.

In this case, the layer thickness of the first adhesion promoter layer is approximately 50 μm and the layer thickness of the second ODS-reinforced layer is approximately 20 μm. The high-temperature protection layer arranged thereon, comprising Yb₂Si₂O₇, has a layer thickness of approximately 200 μm.

Hereinafter, a method according to an embodiment of the invention for producing a TBC system comprising an oxide-dispersion-strengthened second adhesion layer is described.

Amdry 9954 (Co 32Ni 21Cr 8AI 0.5Y), −63 +11 μm, Sulzer Metco, Wohlen, Switzerland) was used as the starting powder for the first adhesion promoter layer (1^{st} APL).

An oxide-dispersion-strengthened (ODS) powder was used for the second adhesion promoter layer (2^{nd} APL). This was produced using the high-energy ball mill Simoloyer CM01 (Zoz i GmbH, Wenden, Germany), by mixing, milling, and finally mechanically alloying, Amdry 995C (Co 32Ni 21Cr 8AI 0.5Y, −90 +45 μm, Sulzer Metco, Wohlen, Switzerland) with 2% by weight α-AI₂O₃ (Martoxid MR70, Martinswerk, Bergheim, Germany).

To control the milling process, 0.5% by weight of the milling adjuvant stearic acid (Ligacid 10-12, C₁₈H₃₆O₂, Peter Greven GmbH & Co. KG, Bad Münstereifel, Germany) were added. 10:1 was selected as the ball-to-powder ratio, and the milling process was carried out at 1400 rpm in a cooled milling chamber having 0.5 l filling volume in an argon atmosphere.

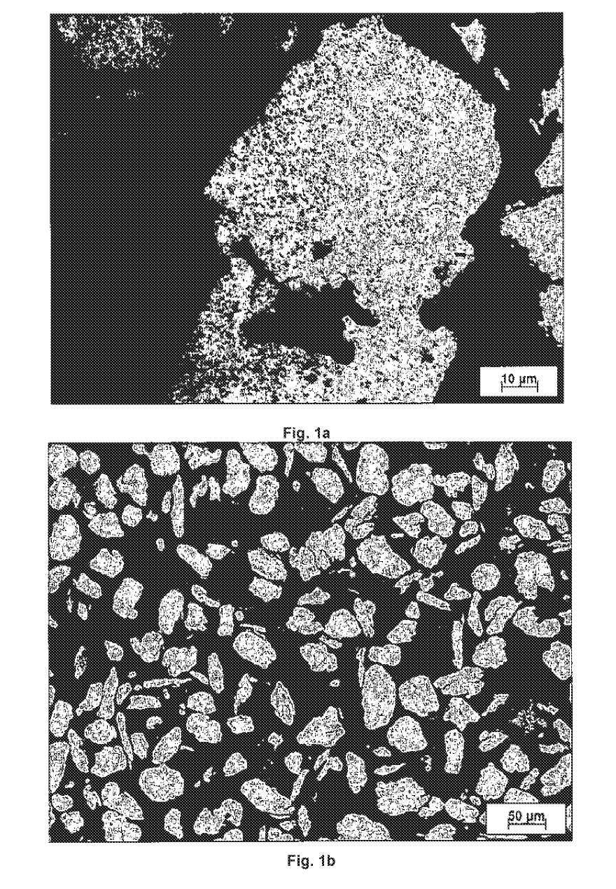

The process was carried out over 6 h, until the oxide dispersions were homogeneously dispersed in the metal matrix and the particles had an irregular morphology. FIG. 1 shows light microscope images of the cross-section of the ODS powder (a) on a 10 μm scale and (b) on a 50 μm scale with embedded oxide dispersions. In FIG. 1(a), the black dots in the gray formation represent the finely distributed oxide dispersions, whilst FIG. 1(b) reproduces the irregular morphology of the ODS powder.

Subsequently, the ODS powder was sieved to a size range of <56 μm. The first adhesion promoter layer and the second adhesion promoter layer were each applied by vacuum plasma spraying (VPS) on an Inconel IN 738 substrate.

As a thermal insulation layer (TIL), 8 YSZ was applied by atmospheric plasma spraying (APS).

The parameters of the vacuum plasma spraying and the thermal spraying method are set out in the following tables:

TABLE 1
PARAMETERS OF THE VPS SEQUENCE

| | | 2^{nd} APL |
|---|---|---|
| | 1^{st} APL | using ODS |
| Current/A | 640 | 680 |
| Hydrogen/NLPM | 9 | 9 |
| Argon/NLPM | 50 | 50 |
| Spraying distance/mm | 275 | 275 |
| Robot speed/mm/s | 440 | 440 |
| Transitions | 4 | 2 |
| Supply disc rotation rate/% | 15 | 15 |
| Stirrer/% | 30 | 30 |

TABLE 2
PARAMETERS OF THE APS SEQUENCE

| | TIL |
|---|---|
| Current/A | 420 |
| Helium/NLPM | 4 |
| Argon/NLPM | 46 |
| Spraying distance/mm | 200 |
| Robot speed/mm/s | 500 |
| Transitions | 10 |
| Supply disc rotation rate/% | 25 |
| Stirrer/% | 30 |

Subsequent to the application, the samples were heat-treated using the following parameters.

TABLE 3
PARAMETERS OF THE HEAT TREATMENT:

| Step | Temperature [° C.] | Time [h] |
|---|---|---|
| 1 | 1120 | 2 |
| 2 | 845 | 24 |

After the heat treatment, the sample was cyclically exposed to a temperature of 1400° C. in gradient tests until failure (temperature of the first adhesion promoter layer approximately 1100° C.) while cooling to room temperature for 120 s everything 300 s.

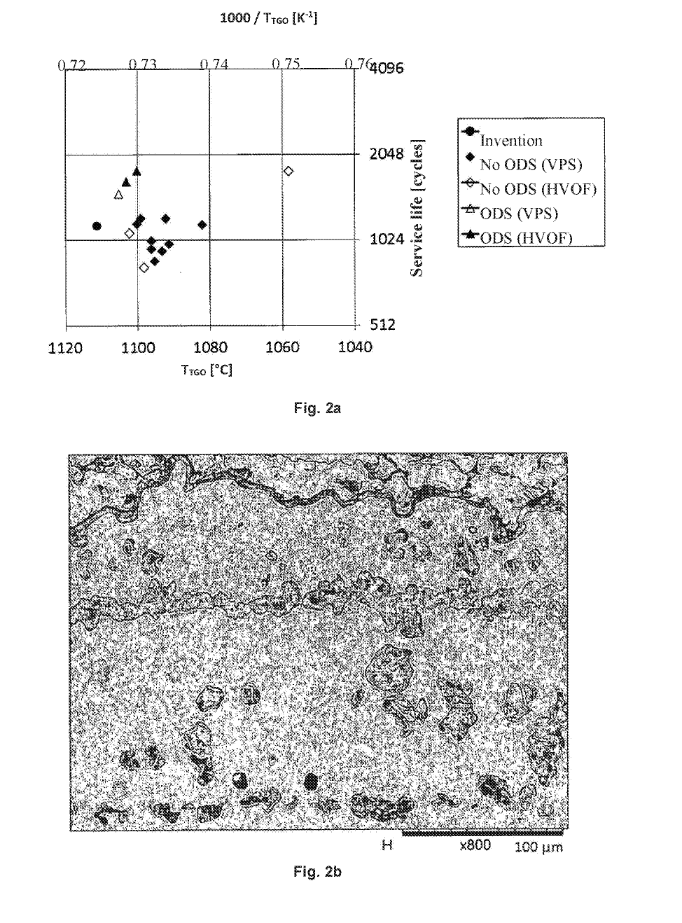

As is shown in the diagram of FIG. 2(a), at 1445 cycles, the sample according to the embodiment comprising a second ODS adhesion promoter layer has a longer service life than thermal insulation systems not comprising an ODS adhesion promoter layer and comparable with thermal insulation systems having pure ODS adhesion promoter layers. The samples not comprising an ODS adhesion promoter layer have a typical adhesion promoter layer of MCrAlY and were applied both by VPS and by HVOF. In the samples having a pure ODS adhesion promoter layer, this was applied both by VPS and by HVOF as well.

In addition to the first and second adhesion promoter layers, the microstructure of the thermal insulation layer system in accordance with the embodiment, shown in FIG. 2(b), also shows that even after the oxidation attempts there was still β-phase present in the first adhesion promoter layer, which serves as a reservoir for the formation of the thermally grown oxide (TGO) layer.

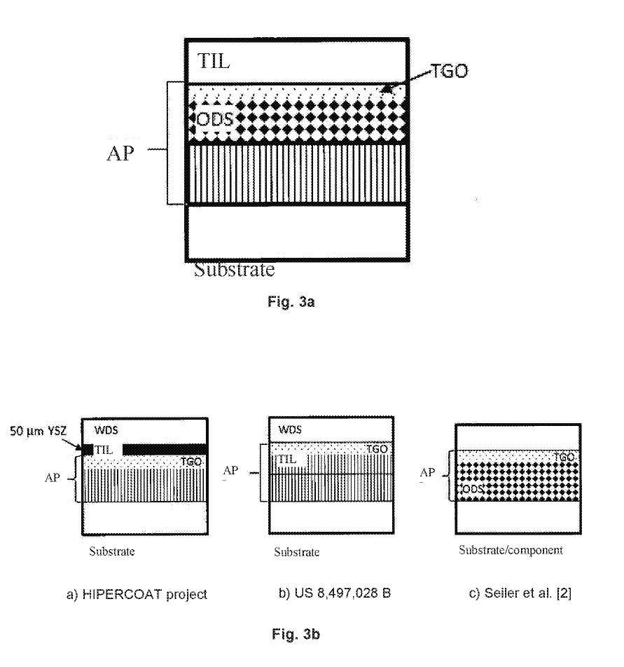

FIG. 3 shows the basic structure of an adhesion promoter layer according to an embodiment of the invention by comparison with the prior art thus far.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCES

[1] W. J. Quadakkers, D. Naumeko, P. Mor, W. Nowak, and L. Singheiser, “Effect of bondcoat roughness on lifetime of APS-TBC-systems in dry and wet gases” in “Thermal Barrier Coatings IV”, U. Schulz, German Aerospace Center; M. Maloney, Pratt & Whitney; R. Darolia, GE Aviation (retired) Eds, ECI Symposium Series, (2015).
[2] P. Seiler, M. Bäker, and J. Rosier, “Variation of Creep Properties and interfacial Roughness in Thermal Barrier Coating Systems”, Advanced Ceramic Coatings and Materials for Extreme Environments (35th International Conference and Exposition on Advanced Ceramics and Composites/ICACC '11), Daytona Beach, 32:129-136, 2011, DOI: 10.1002/9781118095232.ch11

1. An adhesion promoter layer for joining a high-temperature protection layer to a substrate, the adhesion promoter layer comprising:
a first layer of a first adhesion promoter material, provided for application to the substrate, and
a second layer, arranged on the first layer and comprising a second adhesion promoter material comprising additionally introduced oxide dispersions, which is provided for joining a high-temperature protection layer.

2. The adhesion promoter layer according to claim 1, wherein the second layer comprises oxide dispersions in a proportion of 0.01 to 50% by weight.

3. The adhesion promoter layer according to claim 1, wherein the first and/or second adhesion promoter material comprises MCrAIY, where M=Co, Ni, and/or Fe.

4. The adhesion promoter layer according to claim 1, wherein the first and/or second adhesion promoter material comprises Si or an Si alloy.

5. The adhesion promoter layer according to claim 1, wherein the first and second adhesion promoter materials are identical.

6. The adhesion promoter layer according to claim 1, wherein the second layer comprises yttrium oxide, aluminum oxide, zirconium oxide, hafnium oxide or else rare earth oxide dispersions.

7. The adhesion promoter layer according to claim 1, wherein the first layer is thicker than the second layer.

8. The adhesion promoter layer according to claim 1, having a total layer thickness of between 50 and 300 μm, wherein the second layer has a layer thickness of at least 50 μm.

9. A high-temperature protection layer system, comprising a substrate, an adhesion promoter layer according to claim 1, arranged thereon, and a high-temperature protection layer arranged thereon.

10. A high-temperature protection layer system according to claim 9, comprising a substrate, comprising a nickel- or cobalt-based superalloy or a ceramic composite material comprising C/C, C/SiC, SiC/C—SiC or SiC/SiC as the substrate.

11. A method for producing an adhesion promoter layer for joining a high-temperature protection layer to a substrate, the method comprising:
applying, to the substrate, a first layer comprising a first adhesion promoter material; and,
applying, to the first layer, a second layer comprising a second adhesion promoter material comprising additionally introduced oxide dispersions.

12. The method according to claim 11, wherein the first adhesion promoter material comprising additionally introduced stable oxide dispersions is used as a material for the ODS alloy.

13. The method according to claim 11, wherein adhesion promoter material comprising stable oxide dispersions in a proportion of 0.01 to 50% by weight, is used for the second layer.

14. The method according to claim 11, wherein either Si or an Si alloy or MCrAIY, where M=Co, Ni or Fe, is used as the first and/or second adhesion promoter material.

15. The method according to claim 11, wherein yttrium oxide, aluminum oxide, zirconium oxide, hafnium oxide or-else rare earth oxides are used as additional stable oxide dispersions.

16. The method according to claim 11, wherein at least one of the layers is applied by high-velocity flame spraying, vacuum plasma spraying, cold gas spraying, or atmospheric plasma spraying
